(19) United States
(12) Patent Application Publication
(10) Pub. No.: US 2025/0277598 A1
(43) Pub. Date: Sep. 4, 2025

(54) AIR CIRCULATION APPARATUS CAPABLE OF AUTOMATICALLY CLEANING DUST AND CONTROLLING SMOKE IN AIR SUPPLY AND EXHAUST FILTER

(71) Applicant: CENDORI CO., LTD., Seoul (KR)

(72) Inventor: Moon Soo PARK, Gwangju (KR)

(21) Appl. No.: 19/211,308

(22) Filed: May 19, 2025

Related U.S. Application Data
(63) Continuation of application No. PCT/KR2023/018359, filed on Nov. 15, 2023.

(30) Foreign Application Priority Data
Nov. 23, 2022 (KR) 10-2022-0158506

(51) Int. Cl. F24F 8/108; F24F 7/06; F24F 13/10; F24F 13/20

(52) U.S. Cl. CPC F24F 8/108; F24F 7/06; F24F 13/10; F24F 13/20

(57) ABSTRACT

Provided is the provision of an air circulation apparatus in which an outdoor air inflow space and an indoor air inflow space are formed inside a case and a blower is provided in an outdoor air discharge space, wherein a casing whose one side is connected to an outdoor air inlet and whose other side is provided with a filter is formed in the outdoor air inflow space, wherein a casing whose one side is connected to an indoor air inlet and whose other side is provided with a filter is formed in the indoor air inflow space, wherein dust removal means each provided on one side of each of the filters and configured to shake off the dust attached to the filter are provided, and wherein a dust removal blower is further provided inside the casing formed in the outdoor air inflow space.

### TECHNICAL FIELD

The present invention relates more particularly to an air circulation apparatus capable of automatic dust cleaning of air supply and exhaust filters and smoke removal that can automatically clean filters for protecting a heat exchanger inside the air circulation apparatus from dust in the air supplied to an indoor area by the air circulation apparatus and dust in the air discharged from an indoor area to an outdoor area and can also rapidly remove smoke when a fire occurs or food is burned.

### BACKGROUND ART

In general, air purification apparatuses for ventilating indoor air are intended to cause indoor air to flow outdoors or outdoor air to flow indoors, and are installed in various facilities such as general houses and apartments, as well as schools, hospitals, kitchens, and subway stations.

In particular, among air purification apparatuses, especially a heat recovery-type air purification apparatus has a heat exchanger installed inside a case, and an outdoor air inflow space where outdoor air is introduced, an indoor air discharge space for discharging indoor air to an outdoor area, an outdoor air discharge space for discharging outdoor air to an indoor area, and an indoor air discharge space where indoor air is introduced are formed therein, as shown in FIG. 1.

In addition, the heat exchanger element is a tool for saving energy by enabling heat exchange between indoor air and outdoor air. Air vents for air supply and exhaust are formed in the outdoor air inflow space, indoor air discharge space, outdoor air discharge space, and indoor air inflow space of the air purification apparatus. As a result, an indoor space is controlled to the temperature, humidity, and airflow distribution suitable for human activities, and at the same time, dust in the air is removed.

Meanwhile, dust removal filters are installed on one side of the heat exchanger, i.e., the side where outdoor air is introduced, and on the other side of the heat exchanger, i.e., the side where indoor air is introduced, so that damage to the heat exchanger caused by dust is minimized.

However, until now, an air circulation apparatus having a structure that can automatically clean dust in air supply and exhaust filters as described above has not been developed. Accordingly, after a predetermined period of use of the filters, a worker opens the case of the air circulation apparatus and cleans or replaces the air supply and exhaust filters inside the air circulation apparatus.

### CONVENTIONAL ART LITERATURE

1. Korean Patent Application Publication No. 10-2018-0132745

### DISCLOSURE

### Technical Problem

An object of the present invention is to provide an air circulation apparatus that provides a structure capable of automatically cleaning filters for protecting a heat exchanger inside the air circulation apparatus from dust in the air supplied to an indoor area by the air circulation apparatus and dust in the air discharged from the indoor area to an outdoor area and a structure capable of rapidly removing smoke when a fire occurs or food is burned, thereby reducing the possibility that after-sale service is required, eliminating the need to replace or clean the air supply and exhaust filters, and reducing maintenance costs.

### Technical Solution

An embodiment of an air circulation apparatus capable of automatic dust cleaning of air supply and exhaust filters and smoke removal according to the present invention for achieving the above-described object provides an air circulation apparatus in which an outdoor air inflow space and an indoor air inflow space are formed inside a case and a blower for forcibly blowing outdoor air is provided in an outdoor air discharge space, wherein a casing whose one side is connected to an outdoor air inlet and whose other side is provided with a filter is formed in the outdoor air inflow space, wherein a casing whose one side is connected to an indoor air inlet and whose other side is provided with a filter is formed in the indoor air inflow space, wherein dust removal means each provided on one side of each of the filters and configured to shake off the dust attached to the filter are provided, and wherein a dust removal blower is further provided inside the casing formed in the outdoor air inflow space so that dust shaken off the filters by the dust removal means can be discharged through the outdoor air inlet by means of a blowing pressure.

According to an embodiment of the present invention, the casing formed in the outdoor air inflow space and the casing formed in the indoor air inflow space are connected to communicate with each other by a connection passage formed inside the case, and a damper is formed in the middle of the connection passage so that the connection passage can be opened and closed.

According to an embodiment of the present invention, the dust removal means each include a brush configured to come into close contact with one side of the filter and rotate, and a motor configured to rotate the brush.

According to an embodiment of the present invention, the outdoor air inlet is divided into two to have dampers formed therein, and dampers are also installed in the indoor air inlet, an outdoor air outlet, and an indoor air outlet, respectively.

### Advantageous Effects

An effect of the present invention described above is to provide a considerably useful invention that provides the structure capable of automatically cleaning the filters for protecting the heat exchanger inside the air circulation apparatus from dust in the air supplied to an indoor area by the air circulation apparatus and dust in the air discharged from the indoor area to an outdoor area and the structure capable of rapidly removing smoke when a fire occurs or food is burned, thereby reducing the possibility that after-sale service is required, eliminating the need to replace or clean the air supply and exhaust filters, and reducing maintenance costs.

### DESCRIPTION OF DRAWINGS

FIG. 1 is a sectional view of a conventional air circulation apparatus;

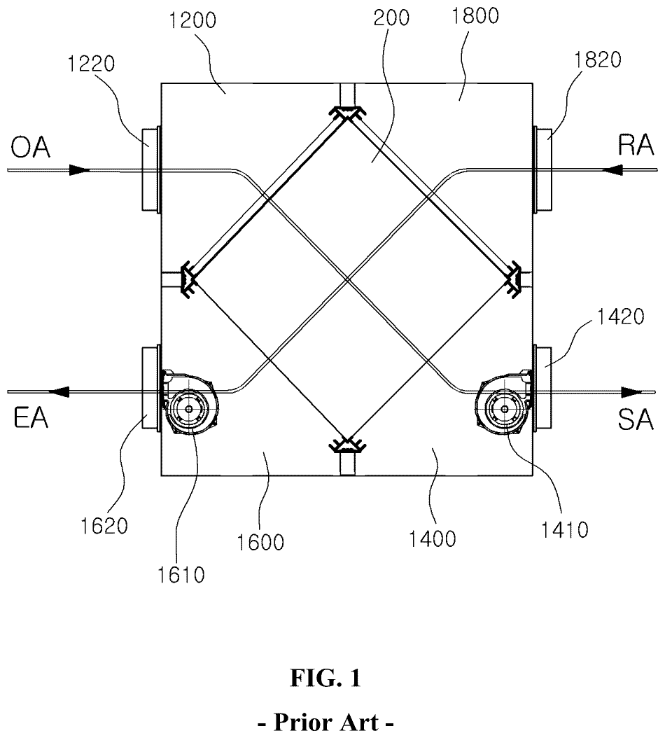

FIG. 2 is a sectional view of an air circulation apparatus according to one embodiment of the present invention;

FIG. 3 is a reference diagram showing an embodiment of a filter and a dust removal means in the present invention;

FIG. 4 is a reference diagram showing air flow for basic air cleaning in the present invention;

FIG. 5 is a reference diagram showing air flow for cleaning the dust shaken off in the casing of an outdoor air inflow space and the casing of an indoor air inflow space in the present invention; and

FIG. 6 is a reference diagram showing air flow for enabling the removal of smoke in the event of a fire in the present invention.

### BEST MODE

Embodiments of the present invention will be described in detail below with reference to the accompanying drawings so that those having ordinary skill in the art to which the present invention pertains can easily implement the present invention. However, the present invention may be implemented in various different forms, and is not limited to the embodiments described herein. The technical terms used herein are intended only to refer to specific embodiments and are not intended to limit the present invention. Furthermore, the singular forms used herein include the plural forms unless the phrases clearly indicate the opposite. The meaning of “including” as used herein specifies a specific characteristic, region, integer, step, operation, element, and/or component, and does not exclude the presence or addition of one or more other specific characteristics, regions, integers, steps, operations, elements, components, and/or groups. Unless otherwise defined, all the terms including the technical and scientific terms used herein have the same meanings as generally understood by those having ordinary skill in the art to which the present invention pertains. The terms defined in commonly used dictionaries are additionally interpreted as having meanings consistent with the relevant technical literature and the present disclosure, and are not to be construed as having ideal or formal meanings unless otherwise defined.

The embodiments of the invention described with reference to the perspective drawings specifically illustrate ideal embodiments of the invention. As a result, various modifications of the drawings, such as modifications in manufacturing methods and/or specifications, are expected. Accordingly, the embodiments are not limited to the specific shapes of the regions depicted, but also include modifications of the shapes due to manufacturing, for example. For example, the regions depicted or described as being flat may generally have rough/rough and non-linear characteristics. Furthermore, the portions depicted as having sharp angles may be rounded. Therefore, the regions depicted in the drawings are only approximates in nature, and their shapes are not intended to depict the exact shapes of the regions, nor are they intended to narrow the scope of the invention.

### MODE FOR INVENTION

Preferred embodiments of the present invention will be described in detail below with reference to the accompanying drawings.

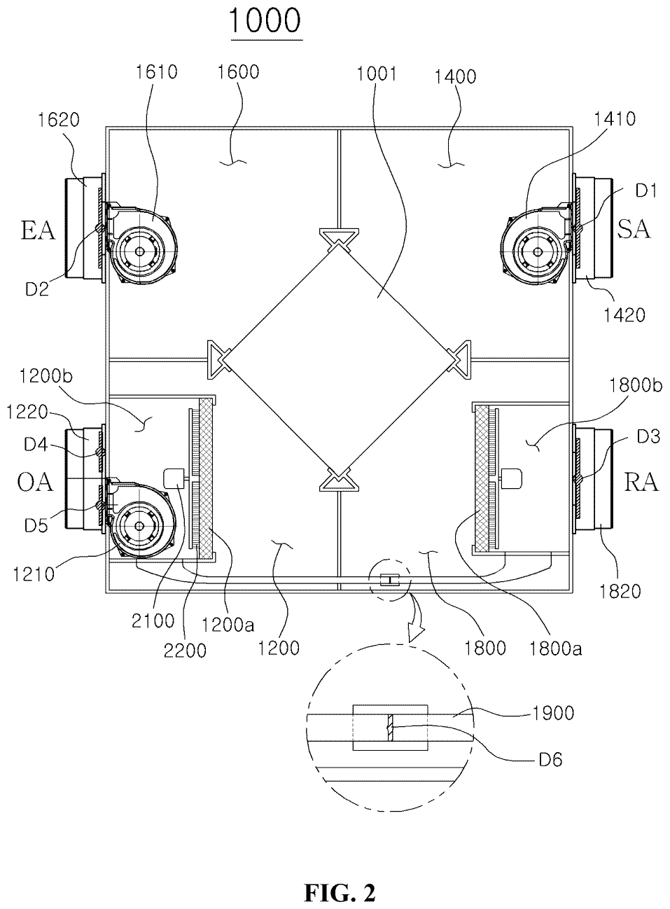

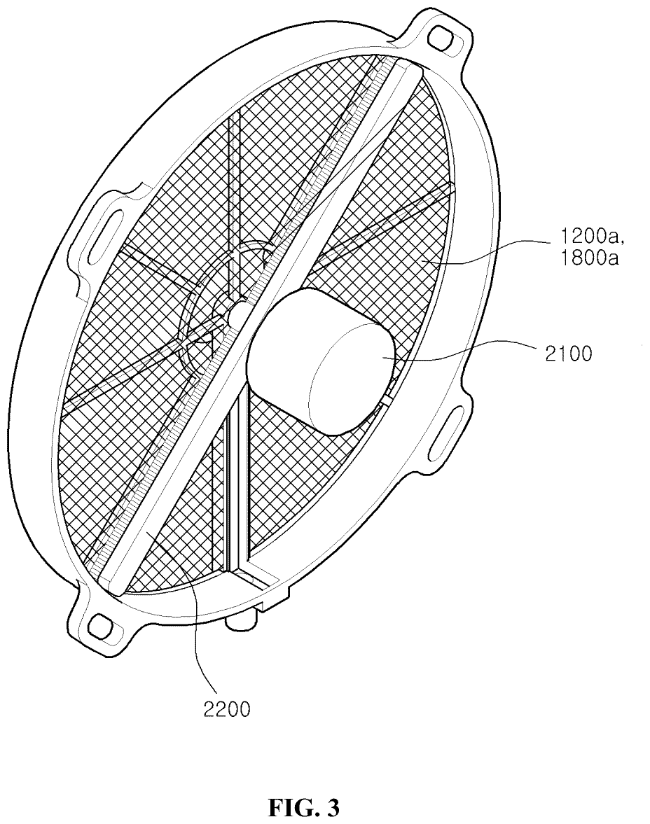

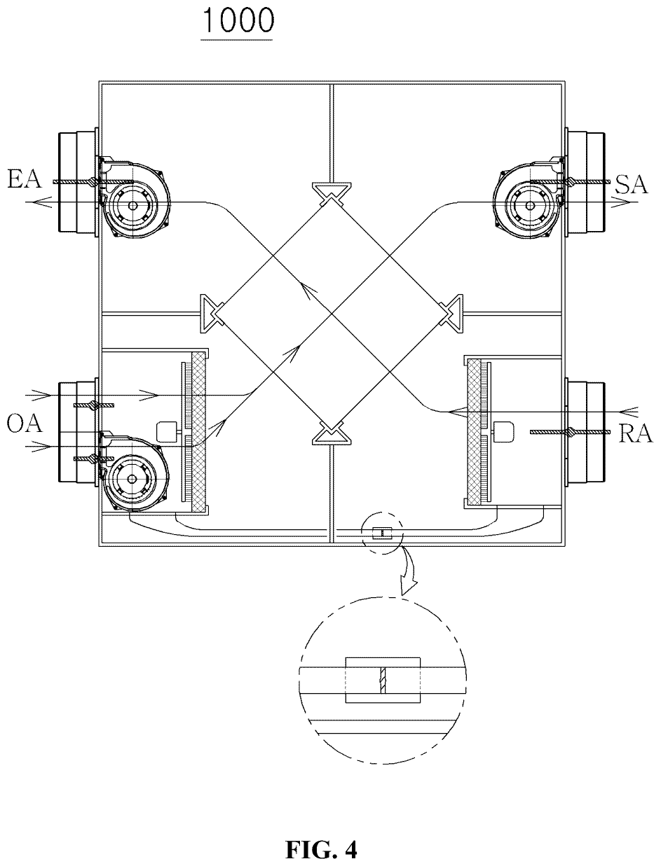

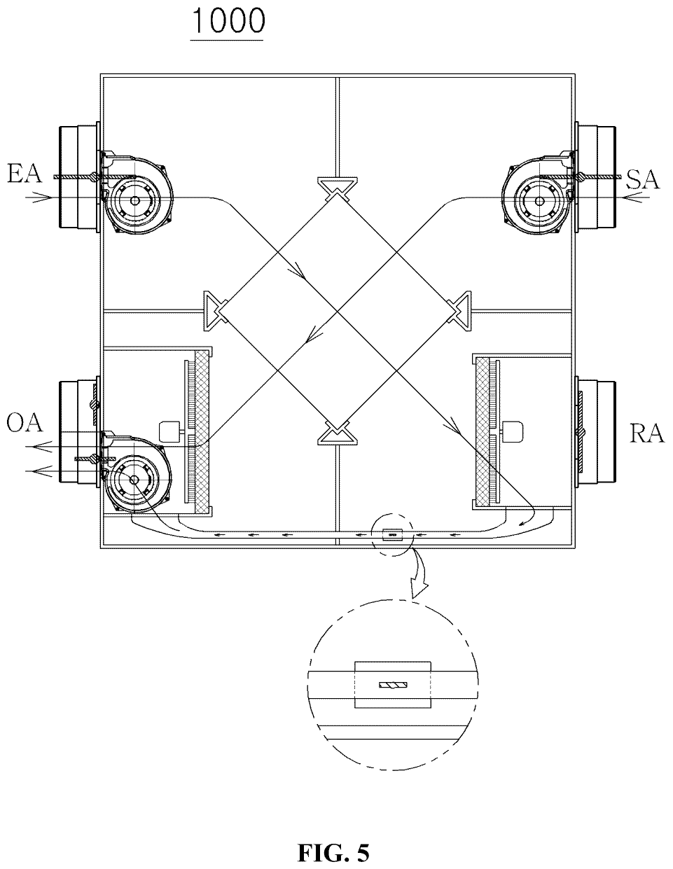

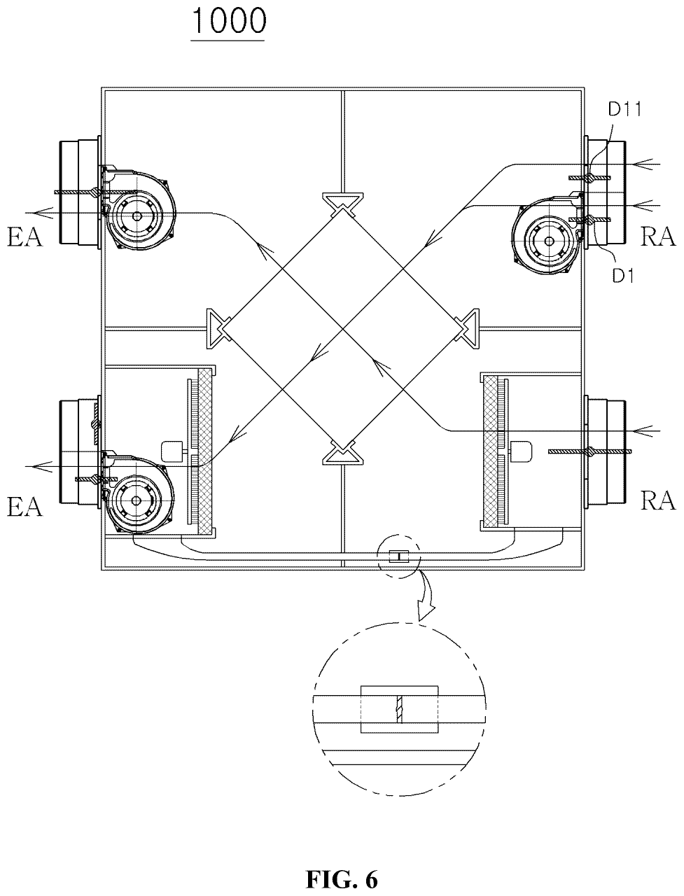

FIG. 2 is a sectional view of an air circulation apparatus according to one embodiment of the present invention, FIG. 3 is a reference diagram showing an embodiment of a filter and a dust removal means in the present invention, FIG. 4 is a reference diagram showing air flow for basic air cleaning in the present invention, FIG. 5 is a reference diagram showing air flow for cleaning the dust shaken off in the casing of an outdoor air inflow space and the casing of an indoor air inflow space in the present invention, and FIG. 6 is a reference diagram showing air flow for enabling the removal of smoke in the event of a fire in the present invention.

First, it should be noted that throughout the drawings, the same components or parts are denoted with the same reference numerals as much as possible. Furthermore, in the description of the present invention, specific descriptions of related known functions or configurations will be omitted in order to avoid ambiguity in the gist of the present invention.

The air purification apparatus 1000 of the present invention includes a case that has a heat exchange element 1001 therein and is partitioned into an outdoor air inflow space 1200, an indoor air discharge space 1600, an outdoor air discharge space 1400, and an indoor air inflow space 1800 around the heat exchange element 1001.

In this case, a casing 1220b configured to communicate with an outdoor air inlet 1220 on one side thereof and provided with a filter 1200a or 1800a on the other side thereof is formed in the outdoor air inflow space 1200 of the air circulation apparatus. A casing 1800b configured to communicate with an indoor air inlet on one side thereof and provided with a filter 1200a or 1800a on the other side thereof is formed in the indoor air inflow space 1800. There are further included dust removal means each formed on one side of one of the filters 1200a and 1800a and configured to remove dust attached to the filter 1200a or 1800a, and a dust exhaust blower 1210 provided inside the casing 1220b that is formed in the outdoor air inflow space 1200. Accordingly, the dust shaken off the filters 1200a and 1800a by the dust removal means may be discharged by means of a blowing pressure via the outdoor air inlet 1220.

The casing 1220b formed in the outdoor air inflow space 1200 and the casing formed in the indoor air inflow space 1800 may be configured to communicate with each other by a connection passage 1900, and a damper D6 may be formed in the middle of the connection passage 1900 so that the connection passage 1900 can be opened and closed. This is a configuration for sucking and discharging dust inside the casing formed in the indoor air inflow space 1800 by the dust exhaust blower formed in the casing 1220b of the outdoor air inflow space 1200.

The above-described dust removal means is preferably configured to include a brush configured to come into close contact with one side of the filter 1200a or 1800a and rotate and a motor fixed to one side of the casing 1200b or 1800b to rotate the brush, as shown in FIG. 3. However, the dust removal means may also be configured to blow air into one side of the filter 1200a or 1800a by means of a known air spray device or the like to shake off dust.

In the present invention, the outdoor air inlet 1220 is divided into two to have dampers D4 and D5 formed therein, and it is preferable to install dampers D1, D2, and D3 in the outdoor air outlet 1420, the indoor air outlet 1620, and the indoor air inlet 1820. In this case, in order to enable a smoke removal operation in the present invention, it is preferable to divide the outdoor air outlet 1420 into two to have dampers D1 and D11 formed therein.

These dampers D1, D2, D3, D4, and D5 are structured to control the flow of indoor air and outdoor air. In a basic mode for air purification, they operate as shown in FIG. 4, whereas in a mode for cleaning the dust that has been shaken off and dropped on the floor by the dust removal means, they operate as shown in FIG. 5.

That is, first, the dust exhaust blower 1210 starts to be operated, the dampers D1, D2, D5 and D6 are opened, and the dampers D3 and D4 are closed. Next, the motor 2100 operates to rotate the brush 2200 and shake off the dust attached to one side of each of the filters 1200a and 1800a. Ultimately, the dust shaken off in this manner is discharged through the outdoor air inlet 1220 by the strong blowing pressure of the dust exhaust blower 1210, so that the filter 1200a or 1800a does not have to be replaced frequently as before and can always be maintained in a clean state.

In addition, the present invention may also operate in a smoke exhaust mode intended to rapidly exhaust indoor smoke to an outdoor area in the event of a fire or the occurrence of smoke by this structure. To do this, in the case where indoor air is exhausted, when the damper D4 is open, the indoor air suction capacity of the blower 1210 decreases, so that the damper D4 is closed to prevent the inflow of outdoor air. This also functions to block outdoor air from flowing into the outdoor area. In this manner, the present invention exhausts indoor air as much as possible while blocking the inflow of outdoor air, thereby reducing the oxygen in the indoor space, and thus, reducing flames and minimizing the growth of the fire.

To this end, when a smoke removal operation is performed, the blowers 1210 and 1610 rotate, the dampers D1 and D11 are opened, and all the dampers D1 and D3 connected to the indoor area are also opened, so that the exhaust cross-sectional area can be increased, thereby maximizing the amount of air that is discharged from the indoor area.

It is obvious that a general operation and a smoke removal operation are controlled by the smoke and flame sensing of a fire sensor (not shown) installed on one side of the case of the air purification apparatus 1000 of the present invention or installed in a diffuser or an indoor control box and the control unit (not shown) of the air purification apparatus 1000 of the present invention that controls the blowers and dampers based on the signal of the fire sensor, thereby preventing the spread of flames to the maximum extent. In this case, it is obvious that, even when there is no fire sensor, an operation that is the same as that performed by the fire sensor may be performed by selecting the smoke removal operation set in the control box (not shown) of the air purification apparatus 1000 of the present invention based on a user's judgment.

As described above, although the present invention has been described based on the limited embodiments, the present invention is not limited thereto, and various modifications and variations may be made by those having ordinary skill in the art to which the present invention pertains within the scope of the technical spirit of the present invention and the equivalent ranges of the patent claims to be described below.

### DESCRIPTION OF REFERENCE SYMBOLS

1000: air purification apparatus of the present invention
1200: outdoor air inflow space
1400: outdoor air discharge space
1600: indoor air discharge space
1800: indoor air inflow space
RA: indoor air suction
OA: outdoor air suction
SA: outdoor air indoor discharge
EA: indoor air outdoor discharge

1. An air circulation apparatus capable of automatic dust cleaning of air supply and exhaust filters and smoke removal, in which an outdoor air inflow space and an indoor air inflow space are formed inside a case, a blower for forcibly blowing outdoor air is provided in an outdoor air discharge space, a casing whose one side is connected to an outdoor air inlet and whose other side is provided with a filter is formed in the outdoor air inflow space, a casing whose one side is connected to an indoor air inlet and whose other side is provided with a filter is formed in the indoor air inflow space, and dust removal means each provided on one side of each of the filters and configured to shake off the dust attached to the filter are provided,
wherein a dust removal blower is further provided inside the casing formed in the outdoor air inflow space so that dust shaken off the filters by the dust removal means can be discharged through the outdoor air inlet by means of a blowing pressure;
wherein a damper is formed in the outdoor air inlet;
wherein dampers are installed in the indoor air inlet, an outdoor air outlet, and an indoor air outlet, respectively; and
wherein the casing formed in the outdoor air inflow space and the casing formed in the indoor air inflow space are connected to communicate with each other by a connection passage formed inside the case, and a damper is formed in a middle of the connection passage so that the connection passage can be opened and closed, thereby enabling smoke removal.
